(19) United States
(12) Patent Application Publication
(10) Pub. No.: US 2025/0068045 A1
(43) Pub. Date: Feb. 27, 2025

(54) ADJUSTING MODULE AND PROJECTOR

(71) Applicant: Coretronic Corporation, Hsin-Chu (TW)

(72) Inventor: Yung-Hsiang Chang, Hsin-Chu (TW)

(73) Assignee: Coretronic Corporation, Hsin-Chu (TW)

(21) Appl. No.: 18/800,153

(22) Filed: Aug. 12, 2024

(30) Foreign Application Priority Data
Aug. 23, 2023 (CN) 202311064921.X

(51) Int. Cl. G03B 21/14

(52) U.S. Cl. CPC G03B 21/142

(57) ABSTRACT

An adjusting module configured to adjust a boresight of a lens module is provided. The adjusting module includes a fixed plate, a movable plate and at least one adjusting unit. The movable plate is movably connected to a first surface of the fixed plate. The movable plate is suitable for disposing the lens module. A light-emitting surface of the lens module is on a same side as the first surface, and a light incident surface of the lens module is on a same side as a second surface. Each of the adjusting unit includes a driving member and a driven member. The driving member is pivotally disposed on the fixed plate along a first axis and linked to the driven member. The driven member is movably connected to the fixed plate and the movable plate along a second axis. The first axis is perpendicular to the second axis. When the driving member rotates while taking the first axis as a rotating axis, the driving member drives the driven member to move the movable plate along the second axis. A projector is also provided.

### CROSS-REFERENCE TO RELATED APPLICATION

This application claims the priority benefit of China application serial no. 202311064921.X, filed on Aug. 23, 2023. The entirety of the above-mentioned patent application is hereby incorporated by reference herein and made a part of this specification.

### BACKGROUND

### Technical Field

The disclosure relates to an adjusting module and a projector using the same.

### Description of Related Art

Today's projectors are likely to have an unbalance problem in a lens module relative to an optical path due to component processing tolerances and assembly tolerances, resulting in poor imaging quality of the projectors. For example, a lens module may be composed of a plurality of optical elements (for example, lenses), and issues such as processing tolerances and assembly tolerances may cause respective optical axes of these optical elements to be misaligned. Therefore, if an optical axis of an image beam transmitted by a light valve of the projector is aligned with a first optical element, when the image beam reaches a last optical element, the optical axis of the image beam will deviate from an optical axis of the last optical element, which results in a poor focusing effect of the image beam projected from the lens module, thereby affecting imaging quality.

In order to improve the imaging quality of the projector, the lens module of the existing projector is installed on a movable plate. The movable plate may be moved relative to a fixed plate, so as to move the lens module to adjust the focusing effect of the lens module. However, the existing movable plate and fixed plate are fixed by screw, and a rotating axis of the screw is parallel to a light-emitting direction of the lens module, so that a user needs to adjust the screws from the front of the lens module. At this time, the user is located in the light-emitting direction of the lens module, and the image beam is directed towards the user's eyes, which probably causes danger, and the image beam will be blocked by the user and cannot form an image, so that the user cannot confirm an imaging status of the projector in real-time while adjusting the screw. In addition, since outer lenses of the lens modules are of different sizes, the screw may be blocked by the lens module, making it difficult for the user to adjust the screw from the front.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an adjusting module configured to adjust a boresight of a lens module. The adjusting module includes a fixed plate, a movable plate and at least one adjusting unit. The fixed plate has a first surface and a second surface opposite to each other. The movable plate is movably connected to the first surface of the fixed plate. The movable plate is suitable for disposing the lens module. When the lens module is disposed on the movable plate, a light-emitting surface of the lens module is on a same side as the first surface, and a light incident surface of the lens module is on a same side as the second surface. Each of the at least one adjusting unit includes a driving member and a driven member. The driving member is pivotally disposed on the fixed plate along a first axis and linked to the driven member. The driven member is movably connected to the fixed plate and the movable plate along a second axis. The first axis is perpendicular to the second axis, and the second axis is parallel to a normal direction of the first surface. When the driving member rotates while taking the first axis as a rotating axis, the driving member drives the driven member to move the movable plate along the second axis.

The disclosure provides a projector including an illumination module, a light valve, a lens module and an adjusting module. The illumination module is configured to provide an illumination beam. The light valve is disposed on a transmission path of the illumination beam to convert the illumination beam into an image beam. The lens module is disposed on a transmission path of the image beam and is configured to project the image beam. The adjusting module is configured to adjust a boresight of the lens module. The adjusting module includes a fixed plate, a movable plate and at least one adjusting unit. The fixed plate has a first surface and a second surface opposite to each other. The movable plate is movably connected to the first surface of the fixed plate. The lens module is disposed on the movable plate. A light-emitting surface of the lens module is on a same side as the first surface, and a light incident surface of the lens module is on a same side as the second surface. Each of the at least one adjusting unit includes a driving member and a driven member. The driving member is pivotally disposed on the fixed plate along a first axis and linked to the driven member. The driven member is movably connected to the fixed plate and the movable plate along a second axis. The first axis is perpendicular to the second axis, and the second axis is parallel to a normal direction of the first surface. When the driving member rotates while taking the first axis as a rotating axis, the driving member drives the driven member to move the movable plate along the second axis, so as to move the lens module.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a simple block diagram of a projector according to an embodiment of the disclosure.

FIG. 2 is a schematic diagram of some components of the projector of FIG. 1.

FIG. 3 is an exploded view of the projector of FIG. 2.

FIG. 4 is a front view of an adjusting module of FIG. 1.

FIG. 5 is a partial enlarged view of the adjusting module of FIG. 4.

FIG. 6 is a schematic diagram of the adjusting unit of FIG. 5 from another viewing angle.

FIG. 7 is a schematic diagram of a projector according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an adjusting module and a projector, which facilitates adjusting a focusing effect of a lens module and are adapted to confirm an imaging status of the projector in real-time, thereby improving usage efficiency and usage convenience of the adjusting module and the projector.

Additional aspects and advantages of the disclosure will be set forth in the description of the techniques disclosed in the disclosure.

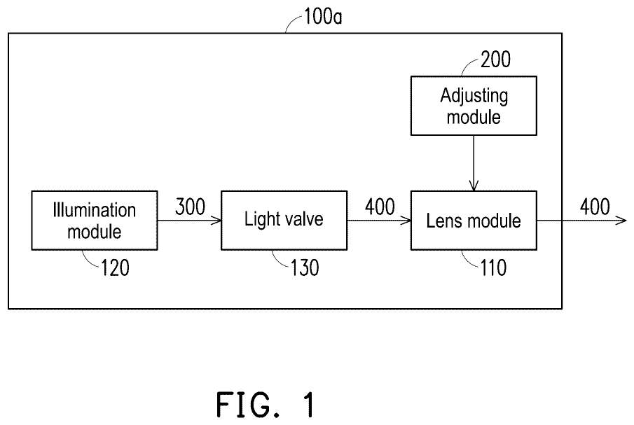

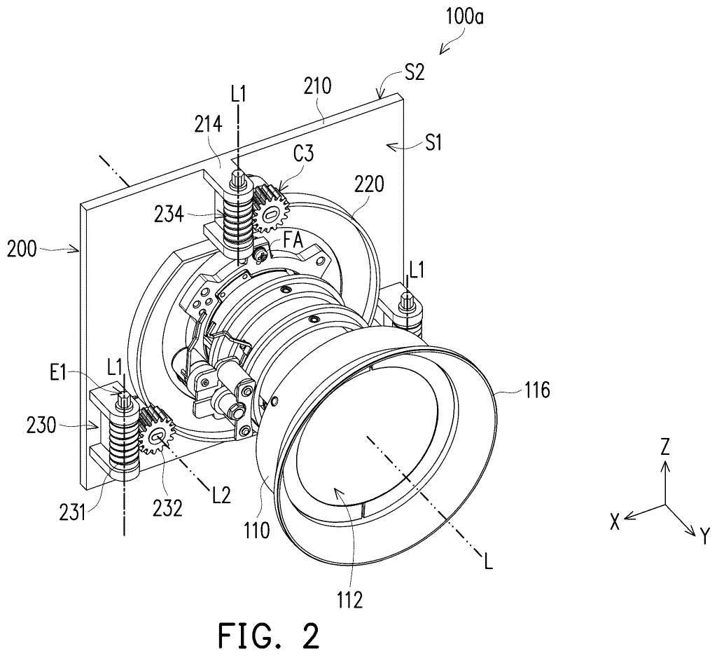

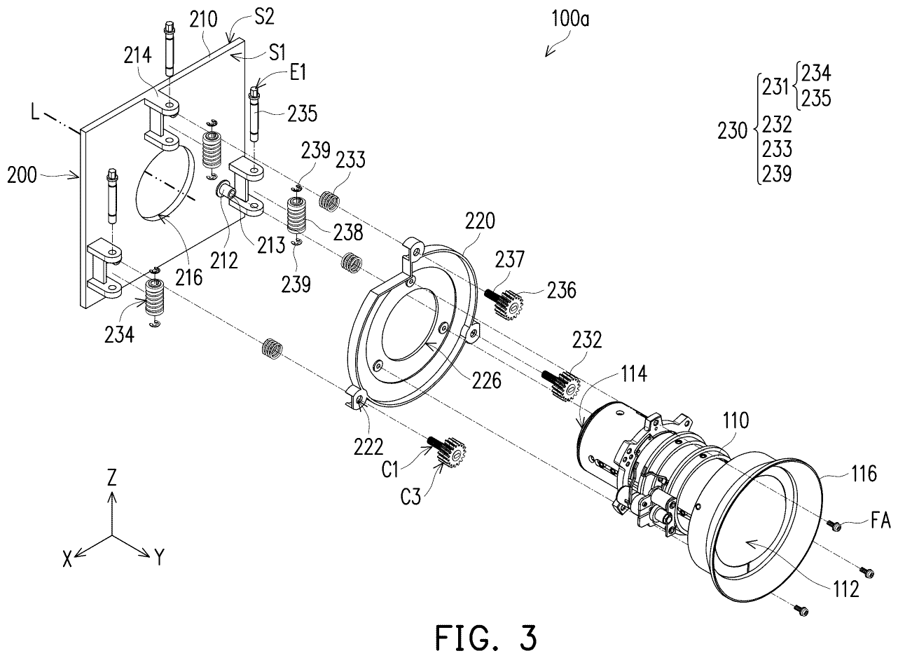

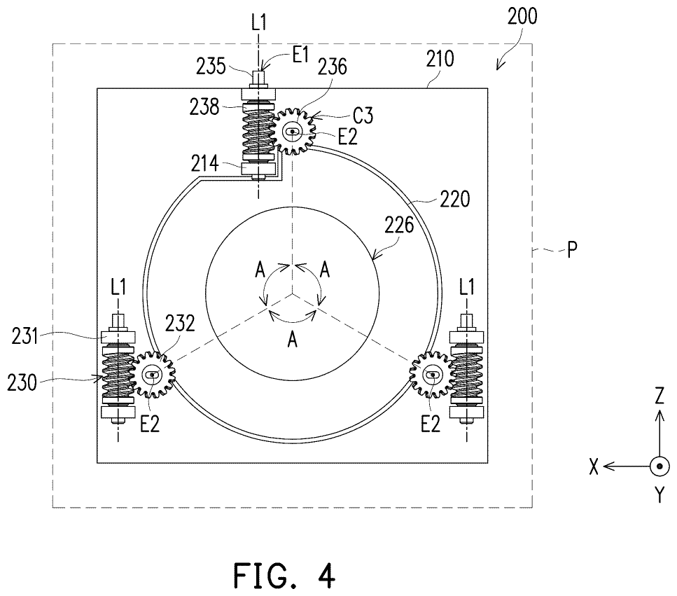

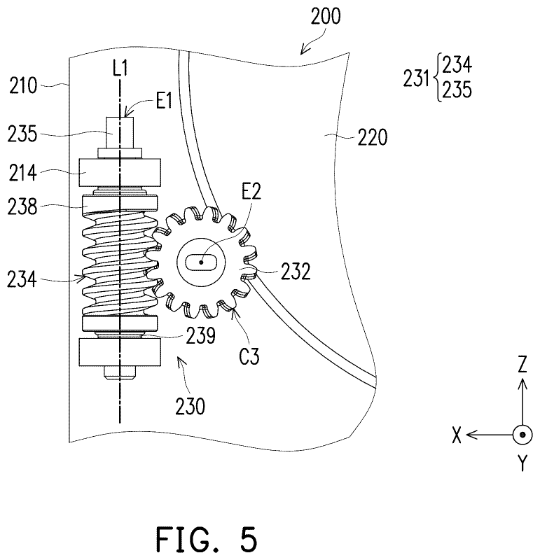

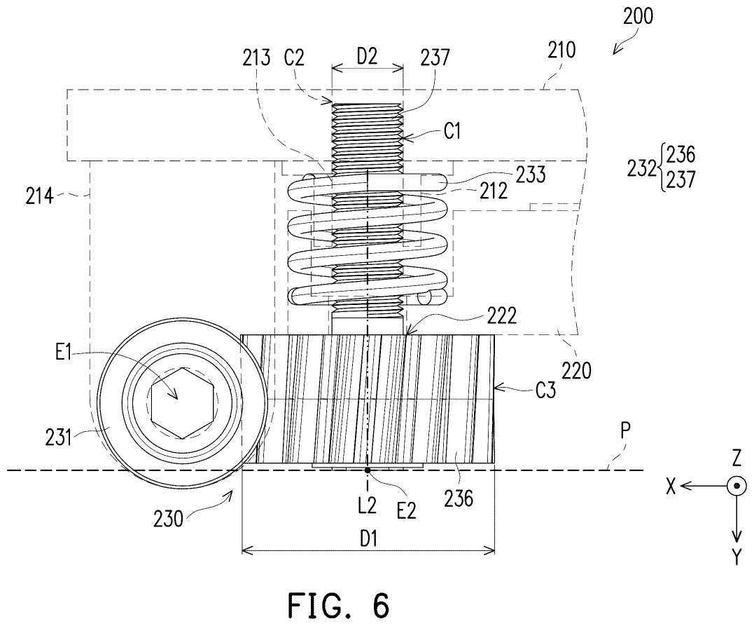

FIG. 1 is a simple block diagram of a projector according to an embodiment of the disclosure. FIG. 2 is a schematic diagram of some components of the projector of FIG. 1. FIG. 3 is an exploded view of the projector of FIG. 2. FIG. 4 is a front view of an adjusting module of FIG. 1. FIG. 5 is a partial enlarged view of the adjusting module of FIG. 4. FIG. 6 is a schematic diagram of the adjusting unit of FIG. 5 from another viewing angle. Cartesian coordinates X-Y-Z are provided here to facilitate component description.

Referring to FIG. 1 to FIG. 6 at the same time, a projector 100a includes an illumination module 120, a light valve 130, a lens module 110 and an adjusting module 200. The illumination module 120 is configured to provide an illumination beam 300. The light valve 130 is disposed on a transmission path of the illumination beam 300 to convert the illumination beam 300 into an image beam 400. The lens module 110 is disposed on a transmission path of the image beam 400 to project the image beam 400 out of the projector 100a. The adjusting module 200 may be used to adjust a boresight of the lens module 110.

Due to issues such as component processing tolerances and assembly tolerances, an optical axis of the image beam 400 emitted by the light valve 130 may be misaligned with the boresight of the lens module 110, resulting in poor focusing effect of the lens module 110, thereby affecting the imaging quality of the projector 100a. In the embodiment, adjusting the boresight of the lens module 110 may be regarded as adjusting a relative position between an optical axis of the lens module 110 and the optical axis of the image beam 400 from the light valve 130, so as to improve the focusing effect of the lens module 110 on the image beam 400, thereby improving the imaging quality of the projector 100a.

The light valve 130 is, for example, a reflective optical modulator such as a liquid crystal on silicon panel (LCoS panel) or a digital micro-mirror device (DMD). In some embodiments, the light valve 130 may also be a transmissive optical modulator such as a transparent liquid crystal panel, an electro-optical modulator, a magneto-optic modulator, an acousto-optic modulator (AOM), etc. In the disclosure, the type and form of the light valve 130 are not limited. Regarding the method for the light valve 130 converting the illumination beam 300 into the image beam 400, sufficient teachings, suggestions and implementation instructions for detailed steps and implementation thereof may be learned from the common knowledge in the technical field, and therefore details thereof will not be repeated. In the embodiment, the number of the light valve 130 is one, for example, the projector 100a uses a single digital micro-mirror device, but in other embodiments, there may be multiple light valves, which is not limited by the disclosure.

The projection lens 110 includes, for example, a combination of one or more optical lenses with refractive power, for example, includes various combinations of non-planar lenses such as biconcave lenses, biconvex lenses, concavo-convex lenses, convexo-concave lenses, plano-convex lenses, plano-concave lenses, etc. In an embodiment, the projection lens 110 may further include a planar optical lens to project the image beam 400 to a projection target (for example, a wall) in a reflective manner. The disclosure does not limit the type and form of the lens module 110.

As shown in FIG. 2 and FIG. 3, the adjusting module 200 includes a fixed plate 210, a movable plate 220 and at least one adjusting unit 230. The fixed plate 210 has a first surface S1 and a second surface S2 opposite to each other. The movable plate 220 is movably connected to the first surface S1 of the fixed plate 210, and the lens module 110 is disposed on the movable plate 220. The movable plate 220 includes a lens hole 226, and the fixed plate 210 includes an opening 216. During assembling, the lens module 110 first penetrates through the lens hole 226 of the movable plate 220 and is fixed to the movable plate 220 through a plurality of fasteners FA. The lens module 110 then penetrates through the opening 216 of the fixed plate 210, so that the movable plate 220 movably connects to the first surface S1 of the fixed plate 210. At this time, a light-emitting surface 112 of the lens module 110 is on a same side as the first surface S1, and a light incident surface 114 of the lens module 110 is on a same side as the second surface S2. The image beam 400 (referring to FIG. 1) is projected out of the projector 100a from the light-emitting surface 112 of the lens module 110. As shown in FIG. 2, a projection direction of the image beam 400 is substantially parallel to a Y-axis.

As shown in FIG. 3, FIG. 5 and FIG. 6, the adjusting unit 230 includes a driving member 231 and a driven member 232. The driving member 231 is pivotally disposed on the fixed plate 210 along a first axis L1 and is linked to the driven member 232. The driven member 232 is movably connected to the fixed plate 210 and the movable plate 220 along a second axis L2. The first axis L1 is perpendicular to the second axis L2, and the second axis L2 is parallel to a normal direction L of the first surface S1. In the embodiment, the second axis L2 is parallel to the Y-axis. The driving member 231 has a rotating end E1, and the rotating end E1 is located on the first axis L1. When the user rotates the rotating end E1 of the driving member 231, so that the driving member 231 rotates while taking the first axis L1 as a rotating axis, the driving member 231 drives the driven member 232 to move the movable plate 220 along the second axis L2, thereby causing the lens module 110 disposed on the movable plate 220 to move. In an embodiment, a moving direction of the movable plate 220 is parallel to the optical axis of the image beam 400.

Specifically, as shown in FIG. 4 to FIG. 6, the adjusting unit 230 of the embodiment further includes an elastic member 233, and the elastic member 233 is, for example, a spring. The driven member 232 includes a head portion 236 and a neck portion 237 connected to each other. A diameter D1 of the head portion 236 is larger than a diameter D2 of the neck portion 237. The elastic member 233 is sleeved on the neck portion 237. When the neck portion 237 of the driven member 232 penetrates through the movable plate 220, the two opposite ends of the elastic member 233 respectively abut against the movable plate 220 and the fixed plate 210, so that the movable plate 220 is located between the elastic member 233 and the head portion 236. The head portion 236 abuts against the movable plate 220. The driven member 232 is movably connected to the fixed plate 210 and the movable plate 220. The head portion 236 of the driven member 232 is correspondingly connected to the driving member 231.

The head portion 236 is, for example, a worm gear C3, and the neck portion 237 of the driven member 232 includes a thread C1. The driving member 231 includes a worm 234, and the driven member 232 meshes with the worm 234 of the driving member 231 through the worm gear C3. The fixed plate 210 is provided with a screw hole C2 at a position corresponding to the neck portion 237 of the driven member 232, and the neck portion 237 is screwed to the screw hole C2 of the fixed plate 210 through the thread C1. When the driving member 231 rotates while taking the first axis L1 as a rotating axis, the worm 234 on the driving member 231 drives the driven member 232 to rotate while taking the second axis L2 as the rotating axis. At this time, the neck portion 237 of the driven member 232 may change a relative position of the thread C1 and the screw hole C2 due to rotation. The elastic member 233 abuts against the movable plate 220, so that the driven member 232 drives the movable plate 220 to move along the second axis L2.

Each driving member 231 of the embodiment corresponds to one first axis L1, and these first axes L1 are parallel to a Z-axis, but the disclosure is not limited thereto. In other embodiments, the first axis L1 may be changed along with the arrangement of the driving member 231 and is not an axis extending in a fixed direction. In the embodiment, the first axis L1 is perpendicular to the second axis L2 (the normal direction L). The rotating end E1 of the driving member 231 faces upward (i.e., a +Z-axis direction), so that the user may rotate the driving member 231 from upper operating. For example, when the worm 234 of the driving member 231 rotates clockwise, the worm gear C3 (head portion 236) of the driven member 232 is driven to rotate counter-clockwise, and the thread C1 (neck portion 237) rotates counter-clockwise relative to the screw hole C2, causing the entire driven member 232 to move forward (i.e., in a +Y-axis direction) along the second axis L2. At this time, the elastic member 233 pushes the movable plate 220, so that the movable plate 220 and the driven member 232 move forward along the second axis L2 relative to the fixed plate 210. When the worm 234 of the driving member 231 rotates counter-clockwise, the worm gear C3 of the driven member 232 is driven to rotate clockwise, causing the thread C1 to rotate clockwise relative to the screw hole C2, and the entire driven member 232 to move backward (i.e. a −Y axis direction) along the second axis L2. At this time, the movable plate 220 is pushed by the head portion 236 of the driven member 232 to move backward and press against the elastic member 233, and the elastic member 233 deforms and accumulates an elastic force.

As shown in FIG. 4, a number of the adjusting units 230 in the embodiment is three. Two end points E2 (for example, an axis of the worm gear C3) of the driven members 232 of the two adjacent adjusting units 230 and a center of the fixed plate 210 (or the opening 216) have an included angle A, and the included angle A is 120 degrees. Namely, a distance between each two adjacent adjustment units 230 is equal. The three end points E2 of the three driven members 232 are located on a virtual plane P, and the virtual plane P is parallel to the movable plate 220. By adjusting any adjusting unit 230 of the driving member 231 to drive the driven member 232 to move along the second axis L2, a relative displacement of the entire virtual plane P (movable plate 220) and the fixed plate 210 in the X-axis, Y-axis and Z-axis may be adjusted. In other embodiments, the angles between the end points E2 (for example, the axis of the worm gear C3) of the driven members 232 of two adjacent adjusting units 230 and the center of the fixed plate 210 may be unequal, and the spirit of the disclosure is met as long as the effect of adjusting the relative displacement of the entire virtual plane P (movable plate 220) and the fixed plate 210 in the X-axis, Y-axis and Z-axis is achieved.

A boresight of the lens module 110 may be adjusted based on moving of the movable plate 220 relative to the fixed plate 210, so as to change a focusing effect of the image beam 400 projected by the lens module 110, and change a projection effect of the projector 100a. In this way, the unbalance problem of the lens module 110 (projector 100a) caused by manufacturing and assembly tolerances may be mitigated or resolved, so as to enhance the imaging quality of the projector 100a.

As shown in FIG. 2, the rotating axis (i.e., the first axis L1) of the driving member 231 of the adjusting unit 230 of the embodiment is perpendicular to a projection direction of the image beam 400 (i.e., the second axis L2 or the normal line L). During the process of adjusting the boresight of the lens module 110, the user may rotate the driving member 231 from upper side (+Z-axis direction) to drive the driven member 232 to move, thereby preventing the user's eyes from being directly illuminated by the image beam 400. Also, the image beam 400 will not be blocked by the user and may be successfully projected (for example, projected onto a wall). The user may confirm an imaging status of the projector 100a in real-time while adjusting the boresight of the lens module 110, so as to adjust the adjusting unit 230 in real-time. In addition, the rotation of the driving member 231 will not be affected by a size of an outer lens 116 of the lens module 110 in the front (+Y-axis direction), which may improve usage efficiency and usage convenience of the projector 100a and the adjusting module 200.

In addition, as shown in FIG. 3, FIG. 5 and FIG. 6, the fixed plate 210 includes at least one fixing member 214 and at least one positioning post 212. The number of the fixing member 214 and the number of the positioning post 212 are respectively three, which correspond to the number of the adjustment unit 230, and the positioning posts 212 are arranged next to the fixing members 214. The movable plate 220 includes at least one mounting hole 222, and a number of the mounting holes 222 is three, which corresponds to the number of the driven members 232 of the adjusting unit 230. The driving member 231 is pivotally connected to the fixing member 214 along the first axis L1. The neck portion 237 of the driven member 232 passes through the mounting hole 222 and is inserted into the positioning post 212. The elastic member 233 is partially sleeved on the positioning post 212. The positioning post 212 extends along the second axis L2 to ensure that the driven member 232 moves along the second axis L2.

As shown in FIG. 6, a size of the mounting hole 222 of the movable plate 220 corresponds to the diameter D2 of the neck portion 237, and the head portion 236 presses against the movable plate 220. The positioning post 212 is a hollow cavity 213 to facilitate forming the screw hole C2 in the cavity 213 (FIG. 6). As shown in FIG. 5, the worm 234 of the driving member 231 of the embodiment is a hollow cylinder 238, and the driving member 231 further includes a rod 235, but the disclosure is not limited thereto. In an embodiment that is not shown, the driving member 231 may be an integrated worm 234 (i.e., the hollow cylinder 238 and the rod 235 are integrated). The rotating end E1 of the driving member 231 is located on the rod 235. The adjusting unit 230 of the embodiment further includes at least two buckles 239. When assembling the driving member 231 to the fixing member 214, the hollow cylinder 238 is first placed in the fixing member 214. Then, the rod 235 passes through the fixing member 214 and the worm 234 (hollow cylinder 238) along the first axis L1 and is fixed to the worm 234 (hollow cylinder 238) through two buckles 239. The two buckles 239 are sleeved on the rod 235 and are located at two opposite ends of the worm 234 (hollow cylinder 238), so that the rod 235 is fixed on the worm 234 and is adapted to drive the worm 234 to rotate.

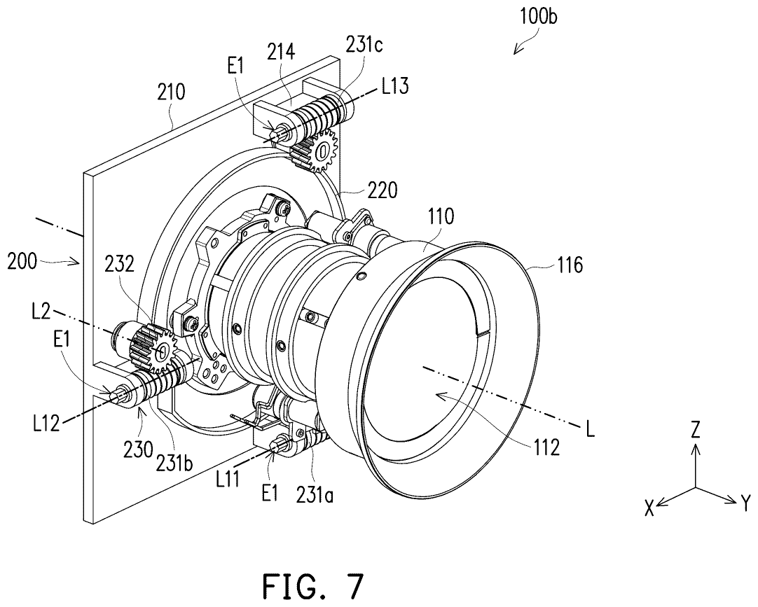

FIG. 7 is a schematic diagram of a projector according to another embodiment of the disclosure. Referring to FIG. 2 and FIG. 7 at the same time, a projector 100b of the embodiment is similar to the previous embodiment, and a difference there between is that three first axes L11, L12, and L13 of the embodiment are parallel to the X-axis, and three rotating ends E1 of three driving members 231a, 231b, and 231c face to the left (i.e., the +X-axis direction). The user may rotate the driving members 231a, 231b, 231c from the left, but the disclosure is not limited thereto. In an embodiment that is not shown, the three first axes L11, L12, and L13 may respectively extend in different directions perpendicular to the second axis L2.

For example, the two driving members 231a and 231c may be arranged along the X-axis direction so that the two first axes L11 and L13 are parallel to the X-axis, and the two rotating ends E1 of the two driving members 231a and 231c may respectively face different directions (the +X-axis direction and the −X-axis direction), and the user may rotate the driving member 231a from the left and rotate the driving member 231c from the right. The driving member 231b may be disposed along the Z-axis direction so that the first axis L12 is parallel to the Z-axis, and the user may rotate the driving member 231b from upper side. The user may respectively rotate the driving members 231a, 231b, and 231c from three different sides. In another embodiment that is not shown, the first axes L11, L12, and L13 may be inclined to the X-axis and the Z-axis. No matter how the driving members 231a, 231b, and 231c are arranged, the first axes L11, L12, and L13 are always perpendicular to the second axis L2. Users may choose the appropriate configuration method according to actual needs.

In summary, the adjusting module of the disclosure and the projector using the same may use the driving member of the adjusting unit to move the movable plate and the lens module arranged on the movable plate to move relative to the fixed plate along the second axis. Since the rotating axis (i.e. the first axis) of the driving member of the adjusting unit is perpendicular to the second axis (which is also the normal direction of the fixed plate), during the adjusting process, the adjusting unit will not be blocked by the lens module, and it is convenient for the user to rotate the driving member, and the user may confirm the imaging status of the projector in real-time to adjust the adjusting unit. In this way, the usage efficiency and usage convenience of the adjusting module and the projector may be improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An adjusting module configured to adjust a boresight of a lens module, comprising:
a fixed plate, having a first surface and a second surface opposite to each other;
a movable plate, movably connected to the first surface of the fixed plate, wherein the movable plate is suitable for disposing the lens module, and when the lens module is disposed on the movable plate, a light-emitting surface of the lens module is on a same side as the first surface, and a light incident surface of the lens module is on a same side as the second surface; and
at least one adjusting unit, wherein each of the at least one adjusting unit comprises a driving member and a driven member, the driving member is pivotally disposed on the fixed plate along a first axis and linked to the driven member, the driven member is movably connected to the fixed plate and the movable plate along a second axis, the first axis is perpendicular to the second axis, and the second axis is parallel to a normal direction of the first surface,
wherein when the driving member rotates while taking the first axis as a rotating axis, the driving member drives the driven member to move the movable plate along the second axis.

2. The adjusting module according to claim 1, wherein the driven member comprises a head portion and a neck portion connected to each other, a diameter of the head portion is greater than a diameter of the neck portion, the neck portion penetrates through the movable plate, the driven member is movably connected to the fixed plate and the movable plate, and the head portion is correspondingly connected to the driving member.

3. The adjusting module according to claim 2, wherein the driving member comprises a worm, the head portion of the driven member is a worm gear, the driven member meshes with the worm of the driving member through the worm gear, and when the driving member rotates while taking the first axis as the rotating axis, the worm on the driving member drives the driven member to rotate while taking the second axis as the rotating axis.

4. The adjusting module according to claim 2, wherein the neck portion of the driven member comprises a thread, the fixed plate is provided with a screw hole at a position corresponding to the driven member, the driven member is screwed to the screw hole of the fixed plate through the thread, and when the driven member is driven by the driving member and rotates while taking the second axis as the rotating axis, the neck portion of the driven member changes a relative position of the thread and the screw hole due to the rotation, so that the driven member drives the movable plate to move along the second axis.

5. The adjusting module according to claim 4, wherein the fixed plate comprises at least one positioning post extending along the second axis, and the at least one positioning post is a hollow cavity, so as to form the screw hole in the cavity.

6. The adjusting module according to claim 3, wherein the worm of the driving member is a hollow cylinder, the driving member further comprises a rod, and the rod passes through and is fixed on the worm.

7. The adjusting module according to claim 6, wherein each of the at least one adjusting unit further comprises at least two buckles, and the at least two buckles are sleeved on the rod and located at two opposite ends of the worm.

8. The adjusting module according to claim 1, wherein each of the at least one adjusting unit further comprises an elastic member, and the elastic member abuts against the movable plate and the fixed plate.

9. The adjusting module according to claim 2, wherein each of the at least one adjusting unit further comprises an elastic member, the elastic member is sleeved on the neck portion of the driven member, and when the neck portion penetrates through the movable plate, the elastic member abuts against the movable plate and the fixed plate, such that the movable plate is located between the elastic member and the head portion.

10. The adjusting module according to claim 1, wherein a number of the at least one adjusting unit is three.

11. The adjusting module according to claim 1, wherein the fixed plate comprises at least one fixing member, and the at least one driving member is pivotally connected to the at least one fixing member along the first axis.

12. A projector, comprising:
an illumination module, configured to provide an illumination beam;
a light valve, disposed on a transmission path of the illumination beam to convert the illumination beam into an image beam;
a lens module, disposed on a transmission path of the image beam, and
configured to project the image beam; and
an adjusting module, configured to adjust a boresight of the lens module, and comprising:
a fixed plate, having a first surface and a second surface opposite to each other;
a movable plate, movably connected to the first surface of the fixed plate, wherein the lens module is disposed on the movable plate, a light-emitting surface of the lens module is on a same side as the first surface, and a light incident surface of the lens module is on a same side as the second surface; and
at least one adjusting unit, wherein each of the at least one adjusting unit comprises a driving member and a driven member, the driving member is pivotally disposed on the fixed plate along a first axis and linked to the driven member, the driven member is movably connected to the fixed plate and the movable plate along a second axis, the first axis is perpendicular to the second axis, and the second axis is parallel to a normal direction of the first surface,
wherein when the driving member rotates while taking the first axis as a rotating axis, the driving member drives the driven member to move the movable plate along the second axis, so as to move the lens module.

13. The projector according to claim 12, wherein the driven member comprises a head portion and a neck portion connected to each other, a diameter of the head portion is greater than a diameter of the neck portion, the neck portion penetrates through the movable plate, the driven member is movably connected to the fixed plate and the movable plate, and the head portion is correspondingly connected to the driving member.

14. The projector according to claim 13, wherein the driving member comprises a worm, the head portion of the driven member is a worm gear, the driven member meshes with the worm of the driving member through the worm gear, and when the driving member rotates while taking the first axis as the rotating axis, the worm on the driving member drives the driven member to rotate while taking the second axis as the rotating axis.

15. The projector according to claim 13, wherein the neck portion of the driven member comprises a thread, the fixed plate is provided with a screw hole at a position corresponding to the driven member, the driven member is screwed to the screw hole of the fixed plate through the thread, and when the driven member is driven by the driving member and rotates while taking the second axis as the rotating axis, the neck portion of the driven member changes a relative position of the thread and the screw hole due to the rotation, so that the driven member drives the movable plate to move along the second axis.

16. The projector according to claim 15, wherein the fixed plate comprises at least one positioning post extending along the second axis, and the at least one positioning post is a hollow cavity, so as to form the screw hole in the cavity.

17. The projector according to claim 14, wherein the worm of the driving member is a hollow cylinder, the driving member further comprises a rod, and the rod passes through and is fixed on the worm.

18. The projector according to claim 17, wherein each of the at least one adjusting unit further comprises at least two buckles, and the at least two buckles are sleeved on the rod and located at two opposite ends of the worm.

19. The projector according to claim 13, wherein each of the at least one adjusting unit further comprises an elastic member, the elastic member is sleeved on the neck portion of the driven member, and when the neck portion penetrates through the movable plate, the elastic member abuts against the movable plate and the fixed plate, such that the movable plate is located between the elastic member and the head portion.

20. The projector according to claim 12, wherein a number of the at least one adjusting unit is three.

21. The projector according to claim 12, wherein the fixed plate comprises at least one fixing member, and the at least one driving member is pivotally connected to the at least one fixing member along the first axis.
